(19) United States
(12) Patent Application Publication
(10) Pub. No.: US 2016/0094922 A1
(43) Pub. Date: Mar. 31, 2016

(54) POSITIONED HEARING SYSTEM

(71) Applicant: Oticon A/S, Smorum (DK)

(72) Inventors: Mogens ØLLGAARD, Smorum (DK); Henning Knak POULSEN, Roskilde (DK)

(73) Assignee: OTICON A/S, Smorum (DK)

(21) Appl. No.: 14/867,844

(22) Filed: Sep. 28, 2015

(30) Foreign Application Priority Data
Sep. 29, 2014 (EP) 14186840.6

(51) Int. Cl. H04R 25/00

(52) U.S. Cl. CPC H04R 25/606; H04R 2225/021; H04R 2225/63; H04R 2460/09; H04R 2460/13

(57) ABSTRACT

The present disclosure regards a hearing system comprising a bony portion fastening unit and a hearing device. The present disclosure further regards a method for arranging a hearing device of a hearing system. The bony portion fastening unit is configured to be arranged in an ear canal of a user, to be permanently connected with a bone of a bony portion of the ear canal, and to penetrate a skin of the bony portion of the ear canal in order to extend in its implanted state from the bone of the bony portion of the ear canal through the skin into a cavity formed by the ear canal. The bony portion fastening unit is configured to fastening and positioning the hearing device in the ear canal.

The present disclosure concerns a hearing system configured to be arranged at least partly in an ear canal and comprising a bony portion fastening unit and a hearing device. Further, the present disclosure concerns a method to arrange the hearing device of the hearing system in the ear canal.

Hearing or auditory perception is the process of perceiving sounds by detecting mechanical vibrations with a sound vibration input. Mechanical vibrations, i.e., sound waves, are time dependent changes in pressure of a medium, e.g. air, surrounding the sound vibration input, e.g. an eardrum of an ear. The human ear has an ear canal that connects the external portion of the ear and the eardrum, the so-called tympanic membrane. The eardrum receives sound waves and transmits them to the inner ear via ossicles. In the inner ear, electrical signals are generated in the cochlear which electrical signal are then interpreted as sound by the human brain. A person with a hearing loss need an amplified and/or otherwise processed sound signal to let the person hear what the person no longer can hear at the normal lower sound pressure level and/or frequencies. The mechanical system of the inner ear have three small bones, the bones Malleus, the Incus and the Stapes, which transmit mechanical energy from the tympanic membrane to the liquid system in the Cochlea. Inside the Cochlea, the energy is transmitted via a liquid to hair cells placed at the nerve ends. The nerves send the sound signal to the brain where the neural stimuli is recognized or perceived as sound.

Hearing aid users face some problems because a hearing aid amplify the sound wave amplitude to transmit a sound. The problems include feedback, occlusion and increased level of wax and moisture in the ear canal.

Feedback includes a situation where sound waves are reflected to the hearing aid microphone after being emitted by the output transducer. The sound waves are picked up by the microphone again and amplified and send out by the output transducer again. This loop will continue until the sound waves are blocked/stopped between the loudspeaker and the microphone. One method to prevent the soundwave going from the loudspeaker back to the microphone is to place a mechanical part in the ear canal to block the ear canal. When there is a closed fitting between the ear canal and the mechanical part the there is no feedback. If the mechanical part is moved slightly out of the ear canal, feedback loop starts again. The mechanical part close the canal and thereby the moisture level will increase in the canal. When the ear canal is closed to prevent feedback, the moisture level will increase. The moisture may be uncomfortable to the user and may lead to e.g. fungus in the ear canal. Ventilating the ear canal to a low moisture level is advantageous for the user of a hearing aid.

Occlusion effect occurs when an object fills the outer portion of a person's ear canal, and that person perceives “hollow” or “booming” echo-like sounds of their own voice. Occlusion is also the perception of a sound and a feeling the person gets, when a mechanical part used for controlling e.g. feedback, moves inside the ear canal. When the person is talking or chewing the ear canal moves and the person can feel the movement of the mechanical part. The person can also hear an unpleasant sound when the mechanical part that stick to wax and liquid in the canal loose the contact to the sticky surface in the canal. Occlusion effect is mainly caused by bone-conducted sound vibrations reverberating off the object filling the ear canal. When talking or chewing, these vibrations normally escape through an open ear canal; most people are unaware of their existence. When the ear canal is blocked, the vibrations are reflected back toward the eardrum. Compared to a completely open ear canal, the occlusion effect can boost low frequency (usually below 500 Hz) sound pressure in the ear canal by 20 dB or more.

The ear canal typically has a sigmoid tube-like shape, which is open at one end towards the environment. The ear canal typically have a length of about 2.3 cm and a typical diameter of about 0.7 cm. Along the ear canal, the ear canal has an outer, flexible portion of a cartilaginous tissue covering about one third of the ear canal length and an inner, bony portion that covers the other two thirds of the ear canal and ends at the eardrum.

A speaker, often referred to as a receiver when talking of hearing aid or hearing instruments, of a hearing aid device can be arranged near the eardrum in the ear canal of a hearing impaired user in order to present amplified and/or processed sound signal from the acoustic environment to allow the user to perceive the sound. In this connection speaker should not be confused with a person speaking, who is often referred to as the talker. In order to optimize the transmission of sound waves to the eardrum the speaker could be positioned in a close distance to the eardrum. Alternatively, a vibration device may be placed close to or in contact with the eardrum/tympanic membrane, in order to directly transmit the sound vibrations to the eardrum. In either case, the positioning of the vibration device with respect to the eardrum is of particular importance in order to avoid, or at least reduce, the risk of damage to the eardrum, e.g. that the vibration device punctures or ruptures the tympanic membrane.

Hearing aids typically comprise a microphone as an input transducer, an output transducer, i.e. a speaker or receiver, a vibration element or any other device that is able to generate a signal perceivable as sound by a user from electrical signals, electric circuitry, and a power source, e.g. typically a battery. Typically, the microphone receives an acoustical sound signal from the environment and generates an electrical sound signal representing the acoustical sound signal. The electrical sound signal is processed, which may include frequency selectively amplification, noise reduction, adjusting processing to a listening environment, and/or frequency transposition or the like, by the electric circuitry to compensate for the users specific hearing loss and a processed output sound signal is generated by the output transducer to stimulate the hearing of the user. In order to improve the hearing experience of the user, a spectral filter bank may be included in the electric circuitry, which could analyse different frequency bands or processes electrical sound signals in different frequency bands individually and allows improving the signal-to-noise ratio.

Hearing aid devices may be worn in or at a single ear, which is referred to as monaurally, or on both ears, which is referred to as binaurally. Binaural hearing aids, or binaural hearing aid systems or binaural hearing systems, comprises two hearing aids, one for the left ear and one for the right ear of the user. The binaural hearing aids may exchange information with each other wirelessly, or via a wired connection.

One way to characterize hearing aid devices is by the way they are mounted at an ear of the user, which typically is reflected by the housing of the hearing aid. Conventional hearing aids include for example ITE (In-The-Ear), RITE/RIE (Receiver-In-The-Ear), ITC (In-The-Canal), CIC (Completely-In-the-Canal), IIC (Invisible-In-the-Canal) and BTE (Behind-The-Ear) hearing aids. For instance, the housing of the ITE hearing aid is located partly in the concha of the ear and partly in the ear canal, while ITC and CIC hearing aid components are located mainly or fully in the ear canal. BTE hearing aids typically comprise a Behind-The-Ear unit, which is generally mounted behind or on the pinna of the user and which hosing is connected to an air filled tube that has a distal end that can be fitted in an ear canal of the user. Sound generated by a speaker can be transmitted through the air-filled tube to an eardrum of the user's ear canal. RITE hearing aids typically comprise a BTE unit arranged behind or on an ear of the user and a unit with a receiver to be arranged in at or in the opening of the ear canal of the user. The BTE unit and the receiver unit are typically connected via a lead. An electrical sound signal may then be transmitted to the receiver, i.e. speaker, arranged in the ear canal via the lead.

Hearing aid users with hearing aids that have at least one insertion part configured to be inserted into an ear canal of the user to guide the sound to the eardrum experience various acoustic effects, e.g., a comb filter effect, sound oscillations or occlusion. Simultaneous occurrence of device generated and natural sound in an ear canal of the user creates the comb filter effect, as the natural and device generated sounds reach the eardrum with a time delay. Sound oscillations, also referred to as howling, generally occur for hearing aid devices including a microphone, with the sound oscillations being generated through sound reflections off the ear canal to the microphone of the hearing aid device. A common way to suppress the aforementioned acoustic effects is to close the ear canal, which effectively prevents natural sound to reach the eardrum via the air in the ear canal and prevents device-generated sound to leave the ear canal. Closing the ear canal, however, leads to the so-called occlusion effect, which corresponds to an amplification of a user's own voice when the ear canal is closed as bone-conducted sound vibrations cannot escape through the ear canal and reverberate off the insertion part of the hearing aid device. To reduce the occlusion effect the insertion part of the hearing aid device may be inserted deeper into the ear canal to adhere to the bony portion of the ear canal and to seal the ear canal.

Another way to avoid the various acoustic effects is to use a vibration element that is directly connected to the tympanic membrane. The vibration element can directly transmit vibrations on the tympanic membrane without generating significant acoustical output sound signals. Therefore a major part of the acoustical effects is avoided. A vibration element, however, has to be positioned with respect to the tympanic membrane in order to be able to transmit the vibrations on the tympanic membrane.

It is an object of the present disclosure to provide an improved hearing system and a method to arrange the hearing system in an ear canal. It is also an object to present an alternative to prior art.

These, and other, objects are achieved by a hearing system comprising a bony portion fastening unit and an insertion part. The bony portion fastening unit is configured to be arranged in an ear canal of a user, to be permanently connected with a bone of a bony portion of the ear canal and to penetrate a skin of the bony portion of the ear canal in order to extend in its implanted state from the bone of the bony portion of the ear canal through the skin into a cavity formed by the ear canal. The bony portion fastening unit comprises a bony portion fastening unit interface. The bony portion fastening unit interface is configured to be arranged in the cavity formed by the ear canal. The insertion part comprises a housing configured to be positioned in the cavity formed by the ear canal. The housing have a housing fastening interface configured to be connected to the bony portion fastening unit interface in order to mount the housing to the bony portion fastening unit. Further, when housing fastening interface is connected to the bony portion fastening unit interface it may help fixate the housing relative to the cavity formed by the ear canal so that the housing is not allowed to move, at least in one direction, uncontrollably further into the cavity, which movements could potentially cause damage to the eardrum and/or skin in the ear canal. The interfaces may be formed so that the user may selectively remove the housing from the ear canal.

The housing may hold input transducer, processor, power source, output transducer etc. as outlined above. In other cases, the input transducer, processor and power, and possibly further components and units, may be placed in a separate, external, housing configured to be positioned behind the ear, and connected to an in-the-ear housing, herein called insertion part. This insertion part then holds at least the interface for the bony portion fastening unit and possibly also the output transducer. In such a case, the output transducer may advantageously be a speaker unit, an ear lens or other suitable output unit. An ear lens may have a biocompatible carrier having a surface shaped to fit a tympanic membrane or ear canal; and a driving element attached to the carrier; wherein, the surface supports a plurality of microscopic setae that are angled with respect to the surface in a pattern that corresponds to a migration pattern of the tympanic membrane. Such an assembly preferably have a biocompatible, removable contact transducer that is supported on the tympanic membrane of a wearer without the use of adhesives or mechanical attachments. The name “ear lens” originates from the installation and removal of the contact transducer assembly that is reminiscent of the method for insertion and removal of contact lenses for the eyes.

Further, the output transducer may further be fitted with an intermediate device. This intermediate device may distribute force to the tympanic membrane, e.g. via deformation or plastic properties.

The input transducer may be configured to receive acoustical sound signals from the environment and further configured to generate electrical sound signals based on the received acoustical sound signals. In other cases, the input transducer may receive signals from external device, which has converted acoustic signals to electrical signal. The electrical signal may be processed, either after being received by the input transducer or before being received by the input transducer, to compensate for a hearing loss of the user. The output transducer may then generate output sound signals based on electrical sound signals. The electric circuitry may further be configured to control the operation of the hearing device.

The input transducer, e.g. a microphone or input receiver such as a wired or wireless interface receiving a signal representing an audio signal, and the output transducer, e.g. a speaker/receiver, a vibration element, a combination of a speaker and a vibration element, or any other device that is able to transmit sound vibrations to a tympanic membrane, can be comprised in the insertion part, such as an In-The-Ear unit, configured to be arranged at least partly in the ear canal of the user, alternatively an electrical signal transmitter for an implant may be included in the insertion part. The other components of the hearing device may be arranged in a Behind-The-Ear unit configured to be arranged behind the ear of the user, i.e. a housing of a RITE-style. Alternatively all components of the hearing device can be arranged fully or partly in the ear canal of the user, e.g., in an In-The-Ear unit, such that the hearing device is of ITE or CIC style.

Output sound signals may for example be acoustical sound signals generated by a speaker, sound vibrations generated by a vibration element or vibrator or other sound signals that allow the stimulation of the hearing of the user. Output sound signals may alternatively, or in combination therewith, be in electrical form, send to an implant in direct communication with the cochlear to stimulate the cochlear electrically.

One aspect relates to a system proving a simple positioning of an insertion part in an ear canal with a predefined distance of an output transducer of the insertion part to a tympanic membrane. This allows for improved sound transmission to the tympanic membrane while avoiding or reducing a majority of unwanted acoustical effects. The present disclosure illustrates how to avoid the use of expensive mechanical components, which are prone to errors and failures. The positioning is in particular relevant for devices, which directly contact the tympanic membrane in order to stimulate hearing of the user by transmission of sound vibrations directly to the tympanic membrane. A correct positioning of the output transducer in order to accurately generate the correct contact force on the tympanic membrane is ensured. Advantageously the insertion device may be placed in the ear canal within a given area so that distance between the tympanic membrane and the insertion device is so that a correct contact force is applied to the tympanic membrane.

In one embodiment, the bony portion fastening unit is inserted into the bone in the bony part of the ear canal so that the bony portion fastening unit penetrates the skin and comprises a bony portion fastening unit interface configured to interface to the insertion part, e.g. an ear lense device or an insertion part including an ear lense, above the skin part. The insertion part comprises the housing fastening interface in order to connect to the bony portion fastening unit interface. More than one bony portion fastening unit may be provided, such as two, three or even more, each of which includes a bony portion fastening unit interface configured to interface to the insertion part. Providing more than one bony portion fastening unit is contemplated to improve the fixation of the insertion part, e.g., the ear lense, in the ear canal. The insertion part can be connected to the bony portion fastening unit interface and will due to the fixed nature of the bony portion fastening unit always be positioned correctly at a predefined distance from the tympanic membrane. The insertion part can have a predefined length between the housing fastening interface and a distal end of the insertion part. Said predefined length between the housing fastening interface and a distal end of the insertion part can be dimensioned to allow the distal end of the insertion part to be positioned in a predefined distance to a tympanic membrane in the ear canal when the bony portion fastening unit interface is connected to the housing fastening interface in the implanted state of the bony portion fastening unit. In one embodiment, the predefined length is below 2 cm, such as below 1.5 cm, such as below 1 cm, such as below 0.5 cm.

The insertion part may further comprise the output transducer. The output transducer can be arranged at or close to the distal end of the insertion part, this means the output transducer can extend over the distal end of the insertion part, e.g., in form of a vibration element comprising a pole and a hammer which directly contacts the tympanic membrane.

In one embodiment a fluid-filled device may be positioned at the distal end of a pole, the fluid-filled device may then be configured to reduce or buffer the transmission of vibrations from the pole to the tympanic membrane so that in the event that reciprocal movement of the pole would otherwise damage the tympanic membrane, at least some of the excessive force is distributed or absorbed by the fluid-filled device. This fluid-filled device may have an outer surface of a skin-friendly material, such as silicone.

The fluid of the fluid-filled device may be a liquid, a paste, a gel or have any other suitable consistency.

The filling may be water-based or oil-based. The filling for the device is preferably non-toxic to humans. The fluid-filled device may define a volume of 0,1 ml to 50 ml, such as 0,2 ml to 20 ml.

The fluid-filled device may have a balloon-type shape, meaning that at one point the fluid-filled device is attached to e.g. a rod-shaped member and the fluid-filled device is free at the other end.

In an embodiment a transducer may be encapsulated in a fluid of liquid filled balloon. The balloon may then be placed in direct contact with the tympanic membrane. When the transducer rod moves inside the liquid filled balloon the sound energy is transmitted to the tympanic membrane.

In an embodiment a transducer rod may be connected to a thin wire. The thin wire may have a fluid or liquid filled balloon attached at the end away from the transducer rod. The liquid filled balloon transmit the sound energy to the tympanic membrane by a direct contact between the balloon and the tympanic membrane. The transducer may then be held in place in the ear canal by having a magnetic needle inserted into the boney part of the ear canal. On the top surface of the needle, there may be a small magnet. The small magnet may have rounded edges. The magnet may be flat surfaced relative to the skin tissue in the ear canal. On the transducer part there may be a magnetic surface matching the magnet on the implanted needle.

The predefined length between the housing fastening interface and a distal end of the insertion part can be dimensioned so as to allow the output transducer to be positioned in a predefined distance to the tympanic membrane in the ear canal. The predetermined distance can be dimensioned so as to provide that the output transducer directly contacts the tympanic membrane with a predefined contact force when the bony portion fastening interface is connected to the housing fastening interface in the implanted state of the bony portion fastening unit.

The hearing system may comprise a magnetic coil. The magnetic coil can be configured to generate magnetic fields in dependence of electrical sound signals. The output transducer can also comprise a magnetic material. In one embodiment the output transducer comprising a magnetic material is configured to transmit audible sound vibrations directly to a tympanic membrane when a magnetic field generated by the magnetic coil is in contact with the output transducer. Therefore the output transducer can be in direct contact to the tympanic membrane, e.g., a magnet being connected to the tympanic membrane and stimulated by the magnetic coil, a combination of the magnetic coil with a magnetic pole and a hammer which directly contacts the tympanic membrane, or other configurations which allow a direct contact between the output transducer and the tympanic membrane.

In one embodiment the output transducer comprises a magnetic material in the form of a magnet attached to the tympanic membrane. The magnetic coil generates a magnetic field, which forces the magnet to oscillate in the magnetic field with a predefined frequency and force. The oscillation of the magnet leads to an oscillation with predefined frequency and force of the tympanic membrane resulting in transmission of acoustic sound signals. It is important for this embodiment of the output transducer that the positioning between magnetic coil and magnet has a predefined distance in order for the magnetic field to work properly, i.e., the forces have to be adequate in order to stimulate hearing and not be too low or too high, which might cause damage to the tympanic membrane.

In one embodiment the output transducer is a vibration element. The vibration element can be configured to generate audible sound vibrations from electrical sound signals. The output transducer can be a speaker. The speaker can be configured to generate acoustical output sound signals from electrical sound signals. Alternatively, the output transducer can be a combination of the vibration element and the speaker. In one embodiment of the vibration element, the vibration element has a magnetic part, which is enclosed by a magnetic coil. The magnetic coil pushes and pulls the vibration element, which directly connects to the tympanic membrane and therefore works like a hammer transmitting sound vibrations directly to the tympanic membrane. The vibration element may vibrate in a way to induce bone conduction, such that the sound vibrations are transmitted via bone conduction. The sound may also be transmitted via bone conduction and as an acoustical sound signal if the output transducer is a combination of a speaker and a vibration element.

In one embodiment the bony portion fastening unit comprises, or is connected to, a ring-shaped element. The bony portion fastening unit may be connectable to the ring-shaped element. The ring-shaped element can be configured to extend around at least a part of a perimeter of the ear canal, e.g., a half perimeter, a full perimeter, nearly full perimeter or other part of a perimeter. In one embodiment the bony portion fastening unit comprises one, two or more screw elements and/or nail elements seated or implanted in the bone of the bony part of the ear canal. The screw and/or nail elements can be configured to connect to the ring-shaped element that extends at least a part of a perimeter, a full perimeter, or at least a substantial part of the perimeter of the ear canal. The ring-shaped element can be configured to connect to the housing fastening interface in a click-connection like manner. The connection between the ring-shaped element and the housing fastening interface can also be based on magnetic forces. Other connections known to the person skilled in the art are also possible, e.g. an adhesive, a screw thread, or other connections.

In one embodiment the housing fastening interface is configured to click into the bony portion fastening unit interface in order to connect to the bony portion fastening unit. The click connection provides a connection for which the bony portion fastening unit interface and the housing fastening interface keep in contact for normal forces applied to the interfaces, e.g., through movements of the user wearing the hearing system. The click connection may be released when a pull force is applied to the click connection, thus allowing the removal of the hearing device by pulling on it. This may be pulling the housing directly or a part connected to the housing, e.g. a pull-out string, tubing connecting the housing to a behind-the-ear housing, or other suitable part.

In one embodiment the housing of the hearing system is a Receiver-In-The-Ear hearing device, also called RITE style hearing device. The Receiver-In-The-Ear hearing device can comprise an insertion part and a Behind-The-Ear unit. The insertion part can comprise the output transducer and the housing fastening interface. The insertion part in this embodiment is configured to be arranged in the ear canal. The Behind-The-Ear unit can comprise the input transducer and the electric circuitry. In this embodiment the Behind-The-Ear unit is configured to be arranged behind an ear of the user.

The hearing device can also be configured to be arranged in an ear or the ear canal of the user, e.g. in form of a In-The-Ear hearing device, also called ITE style hearing device or a Completely-In-The-Canal hearing device, also called CIC style hearing device. Also, any other form of hearing device comprising an in-the-ear-canal part or insertion part is possible.

In one embodiment the bony portion fastening unit and the hearing device comprise at least one magnetic material. The magnetic material is configured to guide and/or hold the hearing device in place when the bony portion fastening unit and the hearing device are in close proximity to each other.

In one embodiment the hearing system comprises at least two bony portion fastening units. The at least one bony portion fastening interface of each of the two bony portion fastening units can be configured to connect to the housing fastening interface.

The present disclosure further relates to a method for establishing proper interface from an output transducer to the tympanic membrane.

The present disclosure further relates to a method for non-surgically arranging a hearing device of a hearing system. The method comprises the step of inserting the hearing device into an ear canal comprising a pre-implanted bony portion fastening interface arranged in a predefined distance to a tympanic membrane. The method further comprises the step connecting the housing fastening interface to the bony portion fastening interface.

Thus the method arranges the hearing device by connecting the hearing device to the bony portion fastening interface that has been pre-implanted in a non-claimed surgical pre-step. The surgical procedure of positioning the bony portion fastening interface in the bone of the bony portion of the ear canal is explicitly not claimed.

The bony part of the ear canal is a good place for penetrating the skin, as natural anti-inflammatory agents will help avoid inflammation in this area. Further, the skin layer is relatively thin. The provision of the bony portion fastening unit in the bone of the bony portion of the ear canal is a minor surgical procedure compared to, e.g., cochlear implantation (CI).

In one embodiment of the method, a predefined length between a housing fastening interface and a distal end of the hearing device is dimensioned such that the output transducer of the hearing device directly contacts the tympanic membrane, when the housing fastening interface is connected to the bony portion fastening interface.

The present disclosure further relates to the use of a hearing system for improving hearing of a user.

The present disclosure will be more fully described with reference to the following detailed description of embodiments, taken together with the drawings in which:

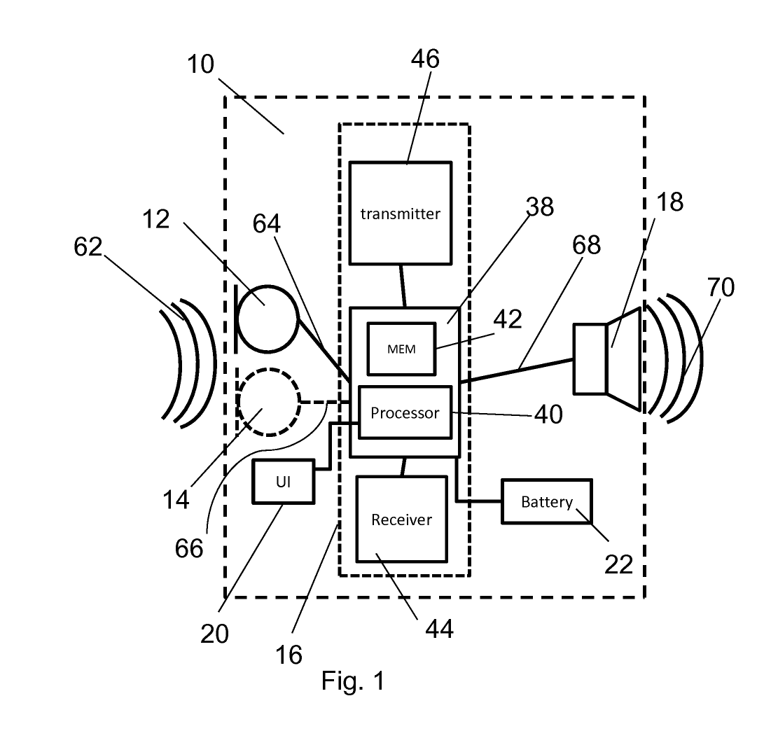

FIG. 1 schematically illustrates an embodiment of a hearing aid;

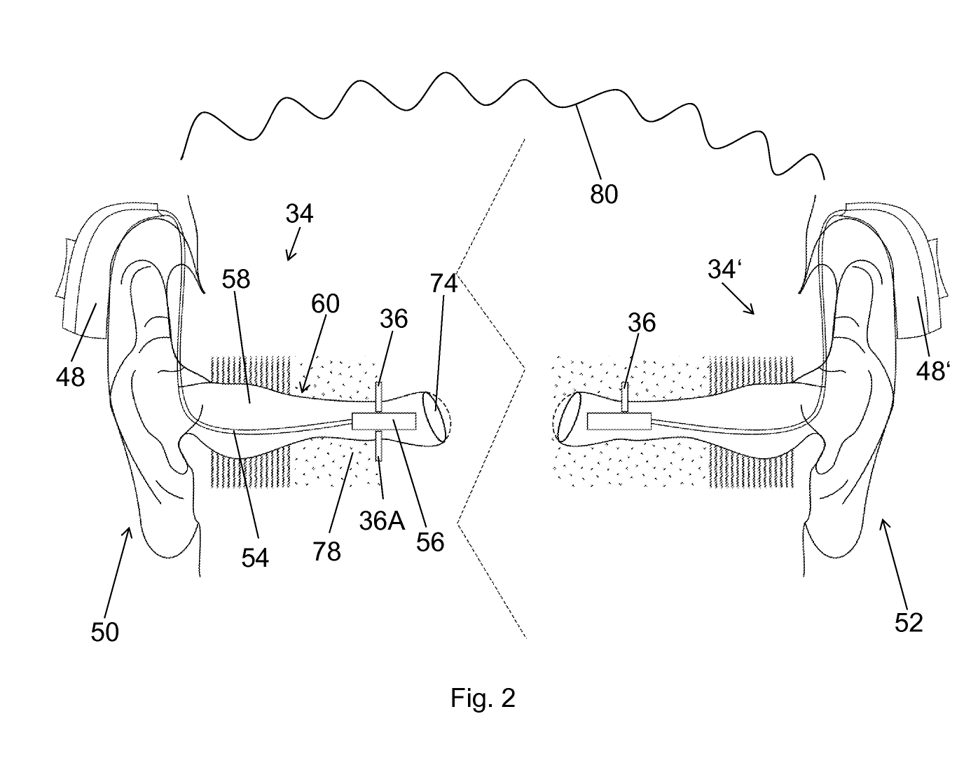

FIG. 2 schematically illustrates an embodiment of a binaural hearing aid system worn at a left ear and at a right ear of a user;

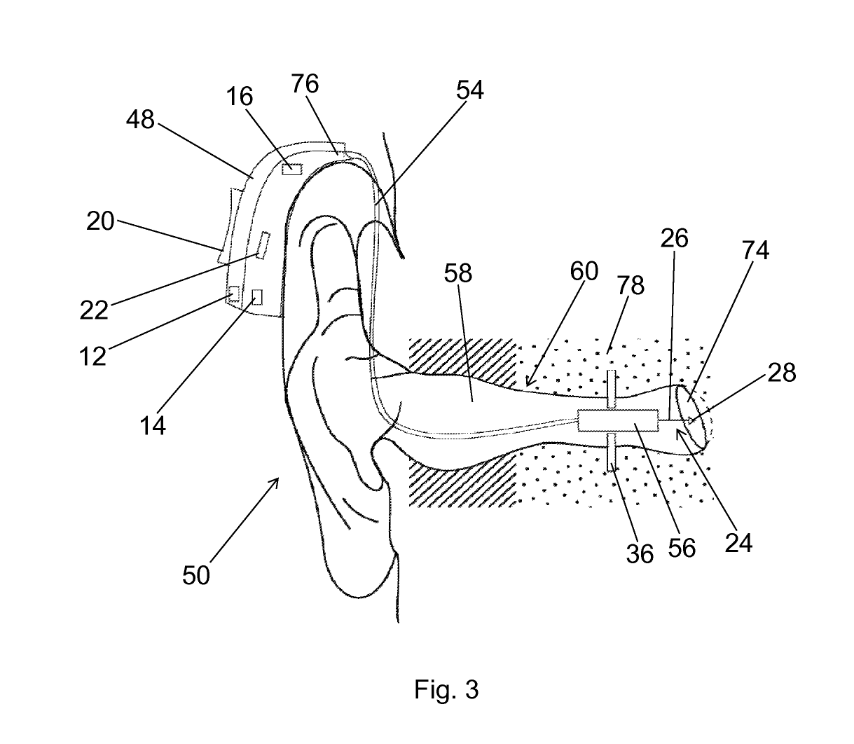

FIG. 3 schematically illustrates an embodiment of a hearing aid system with a RITE-style hearing aid;

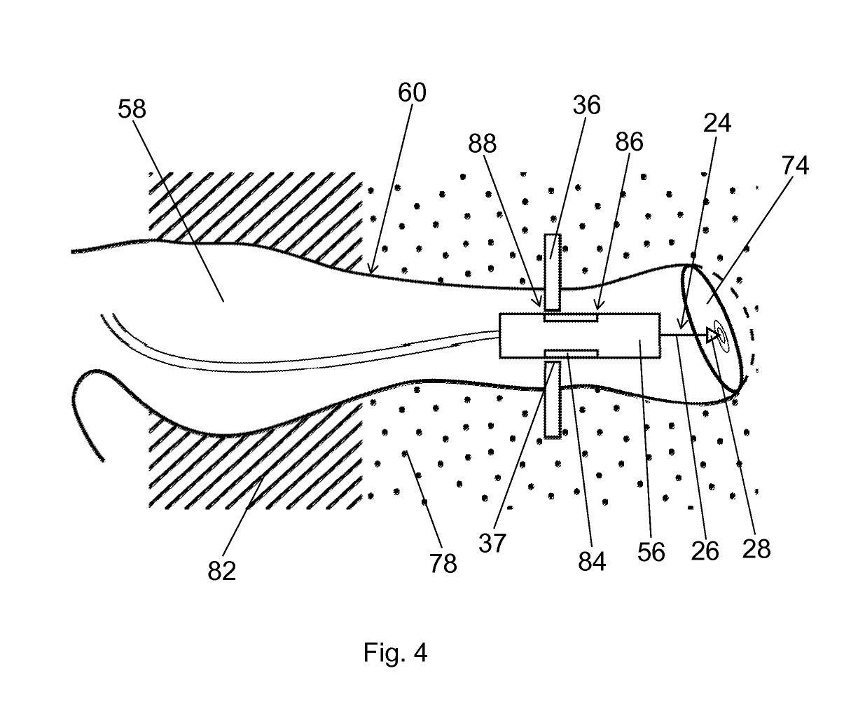

FIG. 4 schematically illustrates a first embodiment of an insertion part of a hearing device positioned in an ear canal;

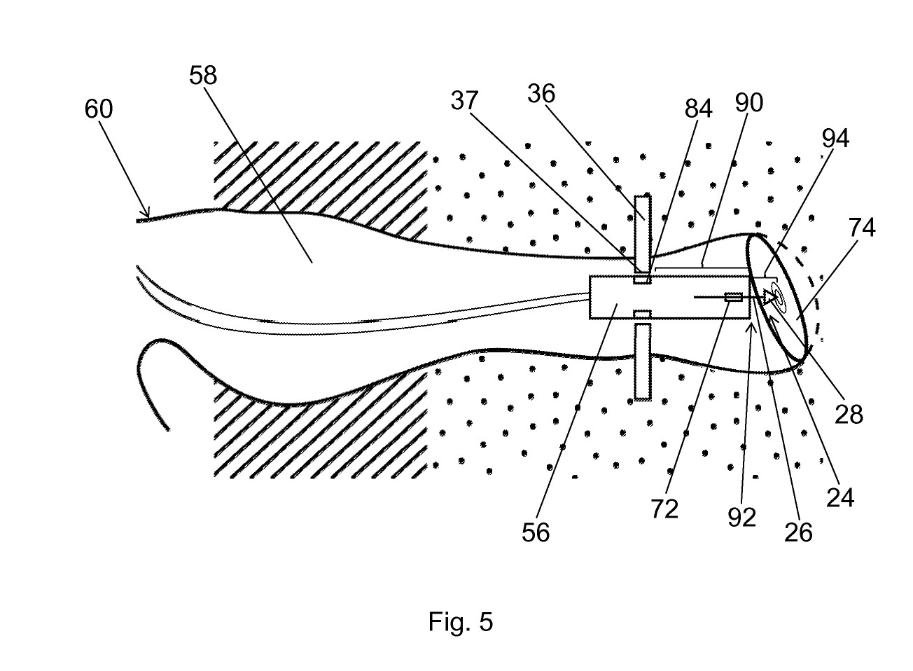

FIG. 5 schematically illustrates a second embodiment of an insertion part of a hearing device positioned in an ear canal;

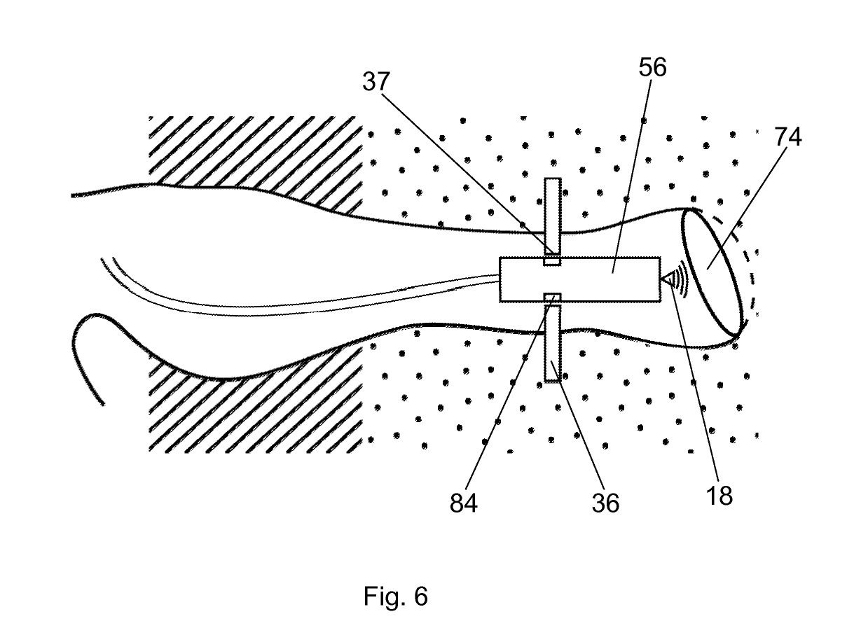

FIG. 6 schematically illustrates a third embodiment of an insertion part of a hearing device positioned in an ear canal;

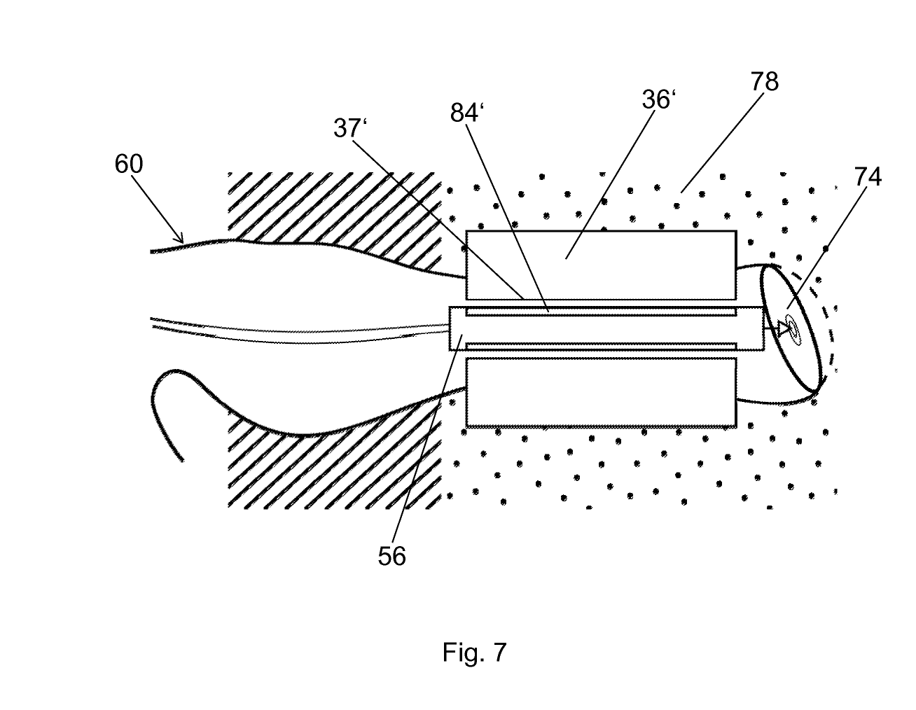

FIG. 7 schematically illustrates a fourth embodiment of an insertion part of a hearing device positioned in an ear canal;

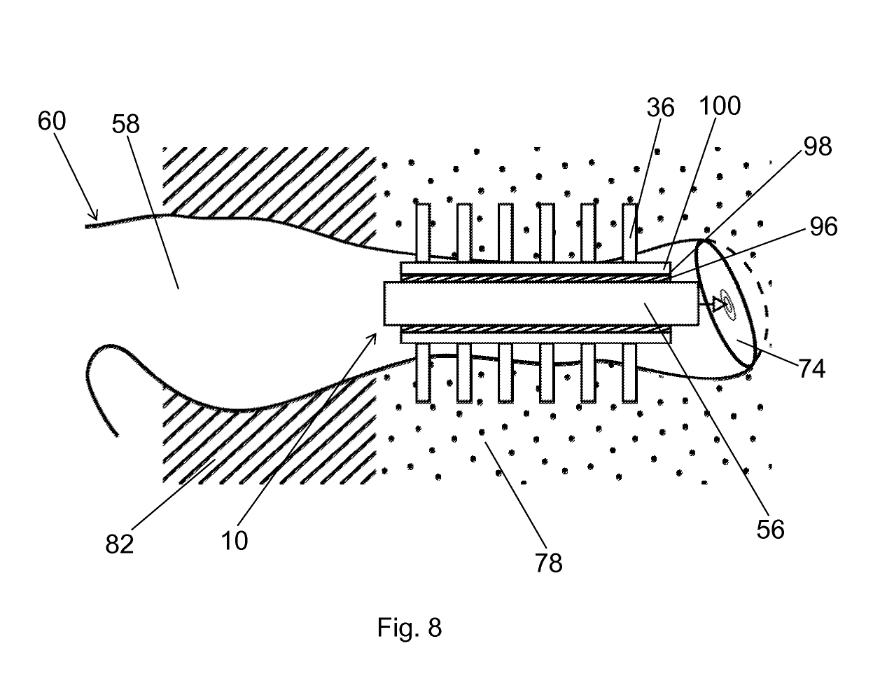

FIG. 8 schematically illustrates a fifth embodiment of an insertion part of a hearing device positioned in an ear canal;

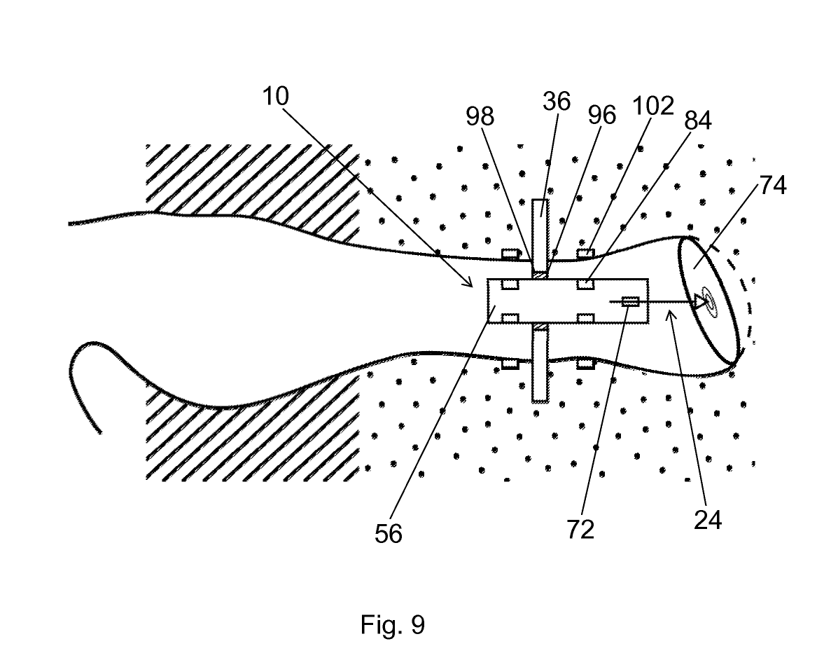

FIG. 9 schematically illustrates a sixth embodiment of an insertion part of a hearing device positioned in an ear canal;

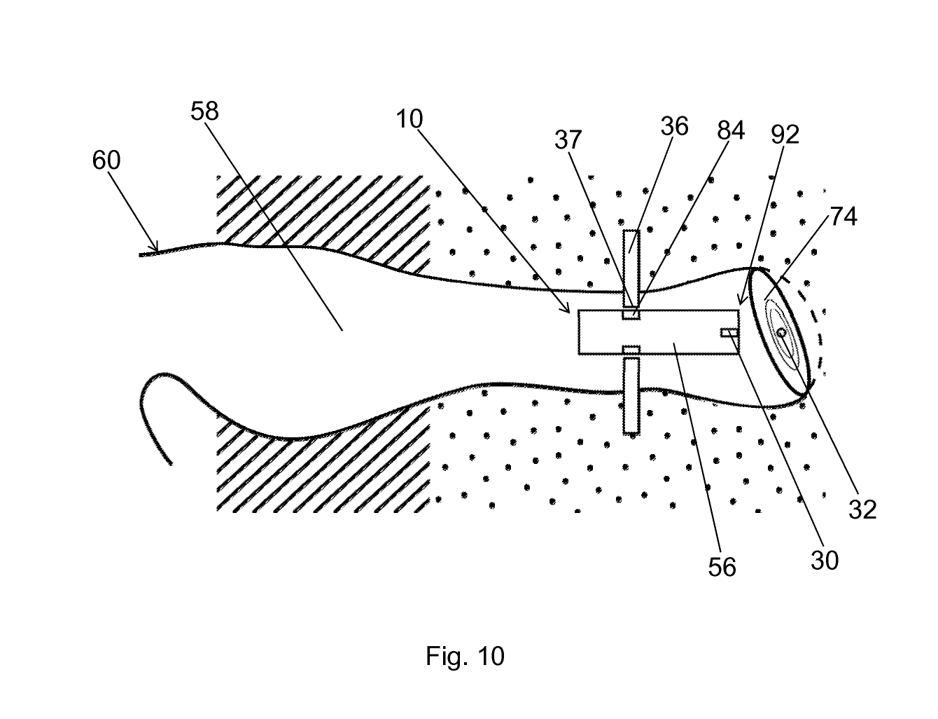

FIG. 10 schematically illustrates a seventh embodiment of an insertion part of a hearing device positioned in an ear canal;

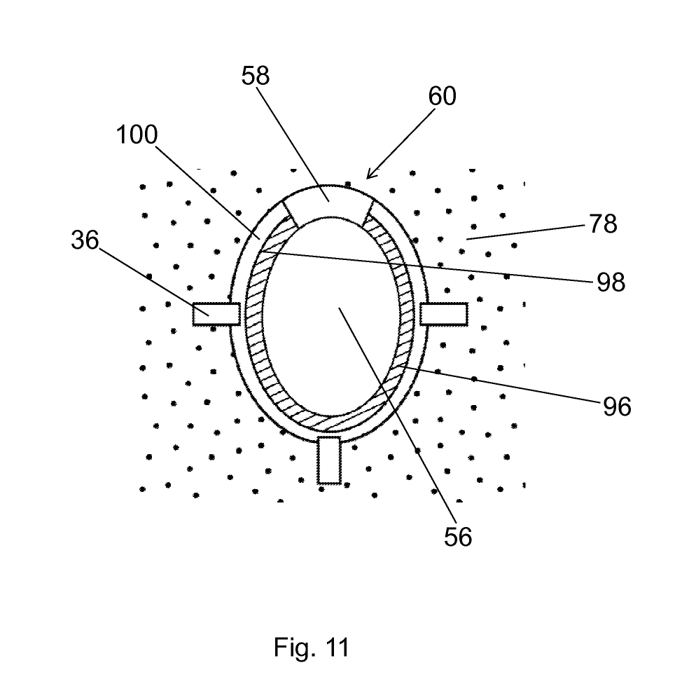

FIG. 11 schematically illustrates a ring-shaped element connected to a bony portion fastening interface in an ear canal;

FIG. 1 schematically illustrates an embodiment of a hearing aid system 10 with two input devices 12 and 14. Here the first input device 12 is a microphone, and the second input device 14 is a telecoil 14. The telecoil 14 is optional. In other embodiments the second input 14 could be a second microphone, or a Bluetooth-Receiver, or an Infrared-Receiver, or any other wireless signal input configured to receive electrical signals wirelessly (not shown). The hearing aid system 10 further comprises electric circuitry 16, a speaker 18, a user interface 20 and a battery 22, electric circuitry 16, a speaker 18, a user interface 20 and a battery 22. In a further embodiment the speaker 18 can be a vibration element 24 with a pole 26 and a hammer 28 (see FIG. 3 or 4), or a pole with a balloon-type transmission element, preferably a fluid or liquid-filled balloon-type, a combination of a magnetic coil 30 and magnetic output transducer 32 (see FIG. 10), a bone vibrator of a bone anchored hearing aid, an array of electrodes of a cochlear implant, or a combination of any of the aforementioned output transducers (not shown). The hearing system 34 (see FIG. 2) is composed of parts establishing the functionality of the hearing aid system 10, and comprises a Behind-The-Ear unit 48, at least one bony portion fastening unit 36 and/or 36A, here in the form of an anchoring pin, an insertion part 56 and a lead 54, the functionality of the individual parts will follow. The Behind-The-Ear unit is often simply referred to as the BTE unit.

A single anchoring pin 36 or 36A may be used to anchor the insertion part 56 in the ear canal of the user. The insertion part 56 may be fully or partly inserted into the ear canal, here it is schematically illustrated that the insertion part 56 is fully inserted into the ear canal. Further, the majority of the electronics of the hearing device is located in a unit placed behind the ear, i.e. the Behind-The-Ear unit 48, and connected to the insertion part 56, e.g. as illustrated in FIG. 2. Either an acoustic signal or an electronic signal is then transferred from the Behind-The-Ear unit 48 to the insertion part 56, which is then used for transferring the signal in acoustic or vibrational form to the eardrum/tympanic membrane.

The electric circuitry 16 comprises a control unit 38, a processing unit 40, a memory 42, a receiver unit 44, and a transmitter unit 46. In the illustration the processing unit 40 and the memory 42 are part of the control unit 38.

The hearing system 34 has a Behind-The-Ear unit 48 configured to be worn at an ear 50 or 52 of a user (see FIG. 2). In FIG. 2 Behind-The-Ear unit 48 and Behind-The-Ear unit 48′ are positioned at respective left and right ear of a user, thereby establishing a so-called binaural hearing system. A lead 54 connects the BTE-unit 48 with the insertion part 56 of the hearing system 34, which is arranged in a cavity 58 of an ear canal 60 of the user.

The hearing system 34 can also be configured to be completely worn in the cavity 58 of the ear canal 60 (see FIGS. 8 to 10).

The hearing system 34 can be operated in various modes of operation, which are executed by the control unit 38 and use various components of the hearing aid 10. The control unit 38 is therefore configured to execute algorithms, to apply outputs on electrical sound signals processed by the control unit 38, and to perform calculations, e.g., for filtering, for amplification, for signal processing, or for other functions performed by the control unit 38 or its components. The calculations performed by the control unit 38 are performed on the processing unit 40. Executing the modes of operation includes the interaction of various components of the hearing aid 10, which are controlled by algorithms executed on the control unit 38.

In a hearing aid mode the hearing aid 10 is used as a hearing aid for hearing improvement by sound amplification, filtering and/or other frequency processing.

The mode of operation of the hearing aid 10 can be manually selected by the user via the user interface 20 or automatically selected by the control unit 38, e.g., by receiving transmissions from an external device, obtaining an audiogram, receiving an acoustical sound signal, receiving wireless sound signals or other indications that allow to determine that the user is in need of a specific mode of operation. Manual selection may e.g. by performed by operating a button or switch on the hearing aid, e.g. the button 20 illustrated in FIG. 3.

The hearing aid 10 operating in the hearing aid mode receives acoustical sound signals 62 with the microphone 12 and wireless sound signals with the telecoil 14. The microphone 12 generates electrical sound signals 64 and the telecoil 14 generates electrical wireless sound signals (WSS) 66, which are then provided to the control unit 38. If both electrical sound signals 64 and 66 are present in the control unit 38 at the same time, the control unit 38 can decide to process one or both of the electrical sound signals 64 and 66, e.g., as a linear combination. The processing unit 40 of the control unit 38 processes the electrical sound signals 64 and 66, e.g. by spectral filtering, frequency dependent amplifying, filtering, or other typical processing of electrical sound signals in a hearing aid generating an electrical output sound signal 68. The processing of the electrical sound signals 64 and 66 by the processing unit 40 depends on various parameters, e.g., sound environment, sound source location, signal-to-noise ratio of incoming sound, mode of operation, type of output transducer, battery level, and/or other user specific parameters and/or environment specific parameters. The electrical output sound signal 68 is provided to the speaker 18, which generates an acoustical output sound signal 70 corresponding to the electrical output sound signal 68 which stimulates the hearing of the user.

In another embodiment the electrical output sound signal 68 is provided to the vibration element 24 which comprises a magnetic coil 72 enclosed around the pole 26, which generates an oscillating magnetic field in dependence of the electrical output sound signal 68 (see FIG. 5). Thus the oscillating magnetic field operates the vibration element 24 by pushing and pulling the pole 26, leading to the hammer 28 hammering on a tympanic membrane 74 (see FIG. 5). The hammering on the tympanic membrane 74 stimulates the hearing of the user.

In yet another embodiment the electrical output sound signal 68 is provided to the magnetic coil 30, which also generates an oscillating magnetic field (see FIG. 10). The oscillating magnetic field forces the magnetic output transducer 32 positioned and adhered at the tympanic membrane 74 to oscillate (see FIG. 10). The oscillation of the magnetic output transducer 32 forces the tympanic membrane 74 to oscillate and stimulates the hearing of the user.

The hearing aid 10 is powered by the battery 22 (see FIG. 1). The battery 22 has a low voltage between 1.35 V and 1.65 V. The voltage can also be in the range of 1 V to 5 V, such as between 1.2 V and 3 V.

The memory 42 is used to store data, e.g., algorithms, operation mode instructions, predetermined electrical output sound signals, predetermined time delays, audiograms, or other data, e.g., used for the processing of electrical sound signals.

The receiver unit 44 and transmitter unit 46 allow the hearing aid 10 to connect to one or more external devices, e.g., allowing the hearing aid 10 to connect to a mobile phone, an alarm, a personal computer or other devices, such as an external programming device used for changing or modifying the operation of the hearing aid 10, e.g. during fitting of the hearing aid 10. The receiver unit 44 and transmitter unit 46 receive and/or transmit, i.e., exchange, data with the external device. The hearing aid 10 can for example exchange algorithms, operation mode instructions, software updates, predetermined electrical sound signals, predetermined time delays, audiograms, or other data used, e.g., for operating the hearing aid 10. The receiver unit 44 and transmitter unit 46 may in some instances be combined in a transceiver unit, such as a Bluetooth-transceiver, a wireless transceiver or wired transceiver, or the like. The receiver unit 44 and transmitter unit 46 can be connected with a connector 76 for a wire, a connector for a cable or a connector for a similar line to connect an external device to the hearing aid 10.

FIG. 2 illustrates a binaural hearing system comprising the hearing systems 30 and 30′ each with a Behind-The-Ear (BTE) unit 48 and 48′. One BTE-unit 48 is mounted behind the left ear 52 and one BTE-unit 48′ is mounted behind the right ear 50 of the user. Each of the BTE units 48, 48′ comprises some or all elements of the hearing aid 10 described in relation to FIG. 1. The speaker 18 (see FIG. 6), the vibration element 24 (see FIG. 3), or the combination of a magnetic coil 30 and the magnetic output transducer 32 (see FIG. 10) may be arranged in the insertion part 56. The insertion part 56 of the hearing system 30 presented in FIGS. 2 to 7 is connected to the BTE-unit 48 via the lead 54. The insertion part 56 is arranged at lest partly in a bony portion 78 of the ear canal 60 of the user, with the distal end close to the tympanic membrane 74. In the Figures, the size of the insertion part is not to scale, as the insertion part 56 may be larger or smaller than illustrated. The insertion part 56 is connected to the anchoring pins 36, which are anchored in a bone of the bony portion 78 of the ear canal 60. The arrangement can be such that the anchoring pins 36 and the insertion part 56 close and seal the ear canal 60 in order to prevent the escape of acoustical output sound signals 70 and intrusion of acoustical sound signals 62. In such a setup, the housing of the insertion part 56 may include an opening to vent the inner part of the ear canal. Acoustical output sound signals 70 generated by the speaker 18 (see FIG. 6), hammering of vibration element 24 (see FIG. 3) or oscillation of magnetic output transducer 32 (see FIG. 10) stimulates the tympanic membrane 74 which allows auditory perception via ossicles, inner ear and brain.

Hearing aid 10 and hearing aid 10′ each comprise a receiver unit 44 and a transmitter unit 46. The combination of receiver unit 44 and transmitter unit 46 can be used to connect the hearing aid 10 with other devices, e.g., with the hearing systems 34 and 36 for binaural operation. If the hearing systems 34 and 36 are operated binaurally the two hearing systems 34 and 36 are in communication with each other, preferably wirelessly. The transmitter unit 46 of the hearing systems 34 transmits data to the hearing systems 36 and the receiver unit 44 of the hearing systems 34 receives data from the hearing systems 36. The hearing systems 34 and 36 can exchange data, e.g., electrical sound signals 64 and 66, electrical output sound signals 68, data signals, audiograms, or other data, via the wireless connection 80.

FIG. 4 shows an insertion part 56 of hearing system 30. The insertion part 56 is shown as inserted into the cavity 58 of ear canal 60 of the right ear 50. When mounting, the insertion part is first guided through the ear canal's cartilaginous portion 82 and then into the part of the ear canal where the bony portion 78 is.

Anchoring pins 36 are anchored to the bone of the bony portion 78. The anchoring pins 36 in this embodiment are of a magnetic material. The anchoring pins may have at least a titanium coating where the anchoring pin is to contact the bone. The anchoring pin may advantageously comprise an external thread. The thread may include one or more cavities to hold bone fragments as the thread cut the bone, so as to alleviate pressure on the bone, which may otherwise cause necrosis of the bone. Further, the thread may be formed so as to compress the bone as little as possible, also to avoid or reduce the risk of bone necrosis. If the bone dies, the anchoring pin may lose its grip in the bone.

The insertion part 56 may also comprises magnetic material at a housing fastening interface 84. In this embodiment the housing fastening interface 84 has a lower doping of magnetic materials at a distal end 86 of the housing fastening interface 84, which increases to a proximal end 88 of the housing fastening interface 84 where the magnetic attraction force is maximal. Thus, the insertion part 56 is guided to the position in which the proximal end 88 of the housing fastening interface 84 connects to the interfaces 37 of the magnetic anchoring pins 36 via magnetic forces between the housing fastening interface 84 and the magnetic anchoring pins 36.

The housing fastening interface 84 can also be magnetized outside of the ear 50 or 52, in order to change the exact position of maximal magnetic attraction force between housing fastening interface 84 and the interfaces 37 of the magnetic anchoring pins 36 along the length of the housing fastening interface 84.

The positioning of the insertion part 56 in the cavity 58 of the ear canal 60 allows the hammer 28 of the vibration element 24 to touch the tympanic membrane 74. When the vibration element 24 is operated as a result of movement of the pole 26, the tympanic membrane 74 can be stimulated in order to stimulate the hearing of the user.

The length of the pole 26 in the embodiment presented in FIG. 4 is fixed. In another embodiment the length of the pole 26 can also be extended or shortened, e.g., by a magnetic coil 72 inside the insertion part 56 (see FIG. 5). The pole 26 can therefore be pushed or pulled in one direction in order to extend or shorten the length of the part of the pole 26, which is external to the insertion part 56. In this way, a fine tuning of the distance of the hammer 28 and the tympanic membrane 74, as well as a fine tuning of the contact force between hammer 28 and tympanic membrane 74 is possible.

FIG. 5 shows a second embodiment of insertion part 56 of hearing system 30. The insertion part 56 is connected to the interfaces 37 of the magnetic anchoring pins 36 via housing fastening interfaces 84. In this embodiment the housing fastening interfaces 84 have the same length as the interfaces 37 provided by the magnetic anchoring pins 36. The insertion part 56 in this embodiment further has a predefined length 90 between the housing fastening interface 84 and a distal end 92 of the insertion part 56. Thus when the housing fastening interfaces 84 are connected to the interfaces 37 of the magnetic anchoring pins 36 a predefined distance 94 between the distal end 92 of the insertion part 56 and the tympanic membrane 74 is established.

The length of the pole 26 of the vibration element 24 is adjusted to the predefined distance 94 in order to bring the hammer 28 in contact with the tympanic membrane 74 with a predefined contact force. 26. The pole 26 comprises a magnetic section, which is enclosed by the magnetic coil 72. The magnetic coil 72 drives the vibration element 24 by pushing and pulling the pole 26. Thereby the hammer 28 stimulates the tympanic membrane 74. In one embodiment the whole length of the pole 26 comprises magnetic material such that the magnetic coil 72 can additionally to pushing and pulling the pole 26, move the pole 26 in order to adjust the length of the part of the pole 26 which is external to the insertion part 56. By adjusting the length of the part of the pole 26 external to the insertion part 56 the contact force between the hammer 28 and the tympanic membrane 74 can be adjusted.

FIG. 6 shows a third embodiment of insertion part 56 of hearing system 30. The third embodiment of insertion part 56 is similar to the embodiment presented in FIG. 5 with the difference that this embodiment comprises a speaker 18 instead of a vibration element 24. The insertion part 56 can also comprise both, a speaker 18 and a vibration element 24 (not shown).

FIG. 7 shows a fourth embodiment of insertion part 56 of hearing system 30. The insertion part 56 comprises a housing fastening interface 84′ extending along almost the whole length of the insertion part 56. The housing fastening interface 84′ connects to the interfaces 37′ of the bony portion fastening unit 36′ which extends along a major part of the bony portion 78 of ear canal 60. In this embodiment the bony portion fastening unit 36′ comprises a magnetic material which connects to the housing fastening interface 84′ via magnetic forces.

FIG. 8 shows a fifth embodiment of insertion part 56 of hearing system 30. In this embodiment the insertion part 56 comprises all components and functions of the hearing aid 10. In an alternative embodiment the insertion part 56 may comprise only a housing fastening interface, an output transducer, and a receiving unit which receives electrical signals from an external hearing aid unit in order to perform sound stimulating operations (not shown), i.e. some of the components and functions of the hearing aid 10.

The insertion part 56 in FIG. 8 comprises an external screw thread 96 which is received by an internal screw thread 98 provided by ring-shaped element 100. The ring-shaped element 100 is securely connected to the anchoring pins 36. The anchoring pins 36 can also be nails or screws extending in the bone of the bony portion 78 and into the ring-shaped element 100. The ring-shaped element 100 can be a part of the bony portion fastening unit or connected to it. The screw threads 96 and 98 provide a secure fastening of the insertion part 56 in a predefined position of the ear canal 60, such that the hearing aid 10 has a predefined distance to the tympanic membrane 74. Thus, the hammer 28 of vibration element 24 is in contact with the tympanic membrane 74 with a predefined contact force.

In an alternative embodiment the screw threads 96, 98 can allow the adjustment of the distance between hearing aid 10 and tympanic membrane 74 in order to increase or decrease the contact force between hammer 28 and tympanic membrane 74. This can be either performed outside the ear 50 or 52 by adjusting the external screw thread 96 or inside of the ear canal 60 by screwing the hearing aid 10.

The insertion part 56 can also comprise an optional vibration element that allows sound vibrations to be conducted via the anchoring pins 36 (not shown). In this case, the hearing system can serve as a bone anchored hearing aid transmitting sound vibrations via bone conduction. Bone conduction hearing improvement can be used when hearing impairment of a user mainly results from hearing impairment in the middle ear, i.e., impairment of the tympanic membrane and/or if one or more of the ossicles is or are impaired. It is also possible to use both the vibration element 24 and the alternative vibration element for bone conduction in order to improve the hearing of the user. Alternatively, also the alternative vibration element and a speaker 18 can be used as output transducers to improve the hearing of the user.

FIG. 9 shows a sixth embodiment of insertion part 56 of hearing system 30. The insertion part 56 in this embodiment comprises two magnetic housing fastening interfaces 84 and an external screw thread 96 in order to securely position the hearing aid 10 in the ear canal 60. The bony portion fastening unit comprises anchoring pins 36 with internal screw threads 98 and magnets 102 implanted in the bone of the bony portion 78. The magnets 102 in this embodiment penetrate the skin. In another embodiment there can also be implanted magnets that are arranged under the skin. The magnets 102 interact with the housing fastening interfaces 84 and the internal screw thread 98 fastens the external screw thread 96 in order to position the hearing aid 10 with a predefined distance to the tympanic membrane 74. The vibration element 24 is powered by the magnetic coil 72 and allows stimulation of the tympanic membrane 74.

FIG. 10 shows a seventh embodiment of insertion part 56 of hearing system 30. The positioning of insertion part 56 in this embodiment is performed identical to the positioning presented of the insertion part 56 in FIGS. 5 and 6. In contrast to the embodiments of FIGS. 5 and 6 the output transducer is changed. In this embodiment the output transducer comprises a magnetic coil 30 arranged at the distal end 92 of insertion part 56. In an alternative embodiment the magnetic coil 30 can have a part external to the insertion part 56 (not shown). The output transducer further comprises a magnetic output transducer 32 which adheres to the tympanic membrane 74. The magnetic output transducer 32 in this case comprises an adhesive that connects the magnetic output transducer 32 to the tympanic membrane 74. Alternatively, the magnetic output transducer 32 can also comprise mechanical means, e.g., small screws, pins, or nails, in order to connect it to the tympanic membrane 74. The magnetic coil 30 generates a magnetic field in dependence of electrical output sound signals 68 in order to stimulate an oscillation of the magnetic output transducer 32. The oscillation of the magnetic output transducer 32 forces the tympanic membrane 74 to oscillate with the same frequency, thus stimulating the hearing of the user.

FIG. 11 shows a cross section of the cavity 58 in the bony portion 78 of the ear canal 60 with the ring-shaped element 100 connected to anchoring pins 36. The cavity 58 is filled by the insertion part 56. In this embodiment, the anchoring pins 36 are screws that permanently connect to the bone of the bony portion 78 and the ring-shaped element 100. The ring-shaped element 100 extends around a major part of a perimeter of the ear canal 60, possibly the entire perimeter. The inner part of the ring-shaped element 100 comprises the internal screw thread 98 that receives an external screw thread 96 of the insertion part 56 (see also FIG. 8).

A method for non-surgically arranging the hearing aid 10 of the hearing system 30 comprises the steps of
inserting the hearing aid 10 into ear canal 60 comprising pre-implanted anchoring pins 36 arranged in a predefined distance 94 to a tympanic membrane 74 and
connecting the housing fastening interface 84 to the interfaces 37 of anchoring pins 36.

Thus the distal end 92 of the insertion part 56, i.e., the distal end of the hearing aid 10, is arranged in the predefined distance 94 to the tympanic membrane 74.

The predefined length between a housing fastening interface 84 and a distal end of the hearing aid 10 is dimensioned such that the vibration element 24 of the hearing aid 10 directly contacts the tympanic membrane 74, when the housing fastening interface 84 is connected to the interfaces 37 of the anchoring pins 36.

### REFERENCE SIGNS

10 hearing aid
12 microphone
14 telecoil
16 electric circuitry
18 speaker
20 user interface
22 battery
24 vibration element
26 pole
28 hammer
30 magnetic coil
32 magnetic output transducer
34 hearing system
36 anchoring pin
37 interface of anchoring pins
38 control unit
40 processing unit
42 memory
44 receiver unit
46 transmitter unit
48 Behind-The-Ear (BTE) unit
50 right ear
52 left ear
54 lead
56 insertion part
58 cavity
60 ear canal
62 acoustical sound signals
64 electrical sound signals
66 electrical wireless sound signals (WSS)
68 electrical output sound signal
70 acoustical output sound signal
72 magnetic coil
74 tympanic membrane
76 connector
78 bony portion
80 wireless connection
82 cartilaginous portion
84 housing fastening interface
86 distal end of housing fastening interface
88 proximal end of housing fastening interface
90 predefined length
92 distal end of insertion part
94 predefined distance
96 external screw thread
98 internal screw thread
100 ring-shaped element
102 implanted magnet

1. A hearing system comprising
a bony portion fastening unit configured to be arranged in an ear canal of a user, configured to be permanently connected with a bone of a bony portion of the ear canal, and configured to penetrate skin of the bony portion of the ear canal in order to extend in an implanted state from the bone of the bony portion of the ear canal through the skin into a cavity formed by the ear canal, the bony portion fastening unit comprising a bony portion fastening interface configured to be arranged in the cavity formed by the ear canal and
an insertion part having a housing configured to be positioned in the ear canal, the housing having a housing fastening interface configured to be connected to the bony portion fastening interface in order to mount the housing to the bony portion fastening unit, insertion part having an output transducer configured to provide a signal perceptible as sound by a user.

2. The hearing system according to claim 1, wherein the insertion part has a predefined length between the housing fastening interface and a distal end of the insertion part, said predefined length being dimensioned to allow the distal end of the hearing device to be positioned in a predefined distance to a tympanic membrane in the ear canal when the bony portion fastening interface is connected to the housing fastening interface in the implanted state of the bony portion fastening unit.

3. The hearing system according to claim 2, wherein the predefined length is below 3 cm, such as below 2 cm, such as below 1.5 cm, such as below 1 cm, such as below 0.5 cm.

4. The hearing system according to claim 2, wherein the output transducer is arranged at or close to the distal end of the insertion part, wherein the predefined length is dimensioned so as to allow the output transducer to be positioned in a predefined distance from the tympanic membrane in the ear canal, or in the alternative wherein the predetermined distance is dimensioned so as to provide that the output transducer directly contacts the tympanic membrane when the bony portion fastening interface is connected to the housing fastening interface in the implanted state of the bony portion fastening unit.

5. The hearing system according to claim 1, wherein the hearing device comprises a magnetic coil configured to generate magnetic fields in dependence of electrical sound signals, wherein the output transducer comprises a magnetic material and wherein the output transducer is configured to transmit audible sound vibrations directly to a tympanic membrane when a magnetic field generated by the magnetic coil is in contact with the output transducer.

6. The hearing system according to claim 1, wherein the output transducer is a vibration element configured to generate vibrations from electrical sound signals or a speaker configured to generate acoustical output sound signals from electrical sound signals or a combination of the vibration element and the speaker.

7. The hearing system according to claim 1, wherein the bony portion fastening unit comprises or is connected to a ring-shaped element configured to extend around at least a part of a perimeter of the ear canal.

8. The hearing system according to claim 1, wherein the housing fastening interface is configured to click into the bony portion fastening interface in order to connect to the bony portion fastening interface.

9. The hearing system according to claim 1, wherein the hearing device is a Receiver-In-The-Ear hearing device comprising an insertion part that comprises the output transducer and the housing fastening interface and wherein the insertion part is configured to be arranged in the ear canal and wherein the hearing device further comprises a Behind-The-Ear unit that comprises the input transducer and the electric circuitry and wherein the Behind-The-Ear unit is configured to be arranged behind an ear of the user.

10. The hearing system according to claim 1, wherein the hearing device is configured to be arranged completely in an ear or the ear canal of the user.

11. The hearing system according to claim 1, wherein the bony portion fastening unit and the hearing device comprise at least one magnetic material configured to guide and/or hold the hearing device in place when the bony portion fastening unit and the hearing device are in close proximity to each other.

12. The hearing system according to claim 1, which comprises at least two bony portion fastening units and wherein at least one bony portion fastening interface of each of the two bony portion fastening units is configured to connect to the housing fastening interface.

13. The hearing system according to claim 1, further comprising a fluid-filled device configured to contact the tympanic membrane when the insertion part is in a mounted state in an ear canal.

14. A method for non-surgically arranging a hearing device of a hearing system according to claim 1, comprising the steps:
inserting the hearing device into an ear canal comprising a pre-implanted bony portion fastening interface arranged in a predefined distance to a tympanic membrane and
connecting the housing fastening interface to the bony portion fastening interface.

15. Use of a hearing system according to claim 1 arranged in an ear canal.

16. The hearing system according to claim 3, wherein the output transducer is arranged at or close to the distal end of the insertion part, wherein the predefined length is dimensioned so as to allow the output transducer to be positioned in a predefined distance from the tympanic membrane in the ear canal, or in the alternative wherein the predetermined distance is dimensioned so as to provide that the output transducer directly contacts the tympanic membrane when the bony portion fastening interface is connected to the housing fastening interface in the implanted state of the bony portion fastening unit.

17. The hearing system according to claim 2, wherein the hearing device comprises a magnetic coil configured to generate magnetic fields in dependence of electrical sound signals, wherein the output transducer comprises a magnetic material and wherein the output transducer is configured to transmit audible sound vibrations directly to a tympanic membrane when a magnetic field generated by the magnetic coil is in contact with the output transducer.

18. The hearing system according to claim 3, wherein the hearing device comprises a magnetic coil configured to generate magnetic fields in dependence of electrical sound signals, wherein the output transducer comprises a magnetic material and wherein the output transducer is configured to transmit audible sound vibrations directly to a tympanic membrane when a magnetic field generated by the magnetic coil is in contact with the output transducer.

19. The hearing system according to claim 4, wherein the hearing device comprises a magnetic coil configured to generate magnetic fields in dependence of electrical sound signals, wherein the output transducer comprises a magnetic material and wherein the output transducer is configured to transmit audible sound vibrations directly to a tympanic membrane when a magnetic field generated by the magnetic coil is in contact with the output transducer.

20. The hearing system according to claim 2, wherein the output transducer is a vibration element configured to generate vibrations from electrical sound signals or a speaker configured to generate acoustical output sound signals from electrical sound signals or a combination of the vibration element and the speaker.
